(19) United States
(12) Patent Application Publication
(10) Pub. No.: US 2011/0040632 A1
(43) Pub. Date: Feb. 17, 2011

(54) MONITIZING PAGE VIEWS ON AN EXCHANGE USING FUTURES CONTRACTS

(75) Inventors: Srinivas Margasahayam, San Jose, CA (US); Satish Mehta, Fremont, CA (US)

Correspondence Address: FIALA & WEAVER P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 12/542,298

(22) Filed: Aug. 17, 2009

(51) Int. Cl. G06Q 30/00

(52) U.S. Cl. 705/14.69

(57) ABSTRACT

Techniques are described herein for monetizing page views on an exchange using futures contracts. For example, an estimated price (a.k.a. base price) and a future date (a.k.a. base date or occurrence date) may be declared with respect to a page view. The estimated price is the price at which the page view is to be offered for sale. The future date is the date on which the page view is scheduled to occur. A futures contract regarding the page view is offered for sale on an exchange, such as an ad exchange. The futures contract specifies an obligation to purchase the page view with respect to the future date for the estimated price. The futures contract may be offered for sale on a date that precedes the date on which the page view is to be offered for sale.

### BACKGROUND OF THE INVENTION

1. Field of the Invention

The present invention generally relates to techniques for monetizing page views on an exchange using futures contracts.

2. Background

An advertisement (“ad”) exchange is a technology platform through which page views (a.k.a. page impressions) may be sold to online advertisers. A page view is said to occur each time a user accesses a Web page. For example, a publisher may offer page views for sale regarding a Web page that is published by the publisher. An advertiser may purchase a designated number of the page views, so that advertisement(s) of the advertiser are served with respect to each of the purchased page views. The page views are usually associated with a specified date or range of dates. For instance, an advertiser may purchase a grouping of page views that are scheduled to occur over a specified period of time (e.g., from January 1^{st} through December 31^{st}, from February 15^{th} through March 14^{th}, etc.).

Page views are traditionally monetized in accordance with classification techniques, such that each class represents a different manner in which page views of that class are to be sold. For example, page views of a first class (e.g., Class I) may correspond to Web pages that are relatively popular, and page views of a second class (e.g., Class II) may correspond to Web pages that are relatively unpopular. In accordance with this example, Class I page views may be sold a designated period of time prior to the date(s) on which the Class I page views are to occur; whereas, the Class II page views may be available for purchase at any time, including the date on which the Class II page views are to occur. As an example, Class I page views may be sold by auction six months in advance of the date on which the Class I page views are to occur. The date on which the Class I page views are sold is referred to as the “advance sale date.” Traditional monetization techniques, such as those described above, may not adequately leverage the revenue generating capabilities of ad exchanges.

Thus, systems, methods, and computer program products are needed that are capable of monetizing page views on an exchange using techniques in addition to or in lieu of traditional monetization techniques.

### BRIEF SUMMARY OF THE INVENTION

Various approaches are described herein for, among other things, monetizing page views on an exchange using futures contracts. The price of a page view with respect to a future date may be estimated using any of a variety of techniques. For instance, an extrapolation technique, such as linear extrapolation, polynomial extrapolation, French curve extrapolation, etc. may be used to estimate the price of the page view. The estimated price (a.k.a. base price) is the price at which the page view is to be offered for sale. The future date (a.k.a. base date or occurrence date) is the date on which the page view is scheduled to occur. The estimated price may be based on any of a variety of factors, including but not limited to the popularity of the Web page with which the page view is associated, historical prices of page views regarding the Web page, the duration of time until the future date on which the page view is to occur, other market factors and/or trends, etc.

A futures contract regarding the page view is offered for sale on an exchange, such as an ad exchange. The futures contract specifies an obligation to purchase the page view with respect to the future date for the estimated price. The exchange provides a platform on which publishers, advertisers, ad networks, etc. may negotiate the placement of ads with respect to page views. The futures contract may be offered for sale for a portion of the estimated price of the page view or for another price. For example, the price of the futures contract may be based on any of the factors that may influence the estimated price of the corresponding page view, historical prices of futures contracts regarding page views that are associated with a Web page corresponding to the futures contract, etc. An advance sale date, which precedes the future date on which the page view is to occur, may be specified on which to offer the page view for sale. For instance, the futures contract may be offered for sale on a sell offer date that precedes the advance sale date.

A purchaser of the futures contract may have a right to sell the futures contract to another party, such as the entity (e.g., publisher) who initially sold the futures contract to the purchaser. Accordingly, the purchaser may essentially serve as a sales agent for the initial seller of the futures contract. Market conditions may enable the purchaser to sell the futures contract at a premium, though conditions may be placed on the right of the purchaser to sell the futures contract.

Example methods are described for monetizing page views on an exchange using futures contracts. A first example method is described in which an estimated price of a page view is calculated with respect to a future date. A futures contract is offered for sale on an ad exchange for a portion of the estimated price on a sell offer date that precedes the future date using one or more processors of a processing system. The futures contract specifies an obligation to purchase the page view with respect to the future date for the estimated price.

A second example method is described in which an advance sale date on which a page view is to be offered for sale for a designated price is specified. The advance sale date precedes an occurrence date on which the page view is to occur. A futures contract is offered for sale on an ad exchange for a portion of the designated price on a sell offer date that precedes the advance sale date using one or more processors of a processing system. The futures contract specifies an obligation to purchase the page view with respect to the occurrence date for the designated price.

Example systems are also described. A first example system includes a calculation module and a sell offer module. The calculation module is configured to calculate an estimated price of a page view with respect to a future date. The sell offer module is configured to offer a futures contract for sale on an ad exchange for a portion of the estimated price on a sell offer date that precedes the future date. The futures contract specifies an obligation to purchase the page view with respect to the future date for the estimated price.

A second example system includes a designation module and a sell offer module. The designation module is configured to designate an advance sale date on which a page view is to be offered for sale for a designated price. The advance sale date precedes an occurrence date on which the page view is to occur. The sell offer module is configured to offer a futures contract for sale on an ad exchange for a portion of the designated price on a sell offer date that precedes the advance sale date. The futures contract specifies an obligation to purchase the page view with respect to the occurrence date for the designated price.

Computer program products are also described. A first computer program product includes a computer-readable medium having computer program logic recorded thereon for monetizing page views on an exchange using futures contracts. The computer program logic includes a first program logic module and a second program logic module. The first program logic module is for enabling the processor-based system to calculate an estimated price of a page view with respect to a future date. The second program logic module is for enabling the processor-based system to offer a futures contract for sale on an ad exchange for a portion of the estimated price on a sell offer date that precedes the future date. The futures contract specifies an obligation to purchase the page view with respect to the future date for the estimated price.

A second computer program product includes a computer-readable medium having computer program logic recorded thereon for monetizing page views on an exchange using futures contracts. The computer program logic includes a first program logic module and a second program logic module. The first program logic module is for enabling the processor-based system to designate an advance sale date on which a page view is to be offered for sale for a designated price. The advance sale date precedes an occurrence date on which the page view is to occur. The second program logic module is for enabling the processor-based system to offer a futures contract for sale on an ad exchange for a portion of the designated price on a sell offer date that precedes the advance sale date. The futures contract specifies an obligation to purchase the page view with respect to the occurrence date for the designated price.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example online advertisement (“ad”) network in accordance with an embodiment described herein.

FIGS. 2A and 2B depict respective portions of a flowchart of a method for monetizing a page view on an ad exchange using a futures contract in accordance with an embodiment described herein.

FIGS. 3, 5, and 10 are block diagrams of example implementations of an ad exchange system shown in FIG. 1 in accordance with an embodiment described herein.

FIG. 4 depicts a flowchart of a method for monetizing a page view on an ad exchange using a futures contract in accordance with an embodiment described herein.

FIG. 6 is a graphical representation of an example relationship between a sell offer price of a futures contract regarding a page view and time in accordance with an embodiment described herein.

FIG. 7 is a graphical representation of an example technique for calculating an estimated price of a page view with respect to a future date in accordance with an embodiment described herein.

FIG. 8 is a graphical representation of an example relationship between a purchase offer price of a futures contract regarding a page view and time in accordance with an embodiment described herein.

FIGS. 9A and 9B depict respective portions of a flowchart of a method for monetizing a page view on an ad exchange using a futures contract in accordance with an embodiment described herein.

FIG. 11 depicts a timeline showing example relationships between respective dates regarding monetization of a page view on an ad exchange using a futures contract in accordance with an embodiment described herein.

FIG. 12 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

The detailed description begins with an introductory section to introduce some of the concepts that will be discussed in further detail in subsequent sections. Example embodiments for monetizing page views on an exchange using futures contracts are then discussed. An example implementation of an online advertisement (“ad”) system is described to provide an example context in which example embodiments may be implemented, though it will be recognized that the scope of the example embodiments is not limited to an online ad system. An example computer implementation is then described, followed by a conclusion section.

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention. For instance, although the embodiments described herein refer specifically, and by way of example, to online advertisement (“ad”) networks, it will be readily apparent to persons skilled in the relevant art(s) that embodiments are equally applicable to other types of networks and/or systems.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Example embodiments are capable of monetizing page views on an ad exchange using futures contracts. The price of a page view with respect to a future date may be estimated using any of a variety of techniques. For instance, an extrapolation technique, such as linear extrapolation, polynomial extrapolation, French curve extrapolation, etc. may be used to estimate the price of the page view. The estimated price is the price at which the page view is to be offered for sale. The future date is the date on which the page view is scheduled to occur. The estimated price may be based on any of a variety of factors, including but not limited to the popularity of the Web page with which the page view is associated, historical prices of page views regarding the Web page, the duration of time until the future date on which the page view is to occur, other market factors and/or trends, etc.

In accordance with example embodiments, a futures contract regarding the page view is offered for sale on an exchange, such as an ad exchange. The futures contract specifies an obligation to purchase the page view with respect to the future date for the estimated price. The exchange provides a platform on which publishers, advertisers, ad networks, etc. may negotiate the placement of ads with respect to page views. In accordance with some example embodiments, the futures contract is offered for sale for a portion of the estimated price of the page view. The price of the futures contract may be based on any of the factors that may influence the estimated price of the corresponding page view, historical prices of futures contracts regarding page views that are associated with a Web page corresponding to the futures contract, etc. In accordance with some example embodiments, an advance sale date, which precedes the future date on which the page view is to occur, is specified on which to offer the page view for sale. For instance, the futures contract may be offered for sale on a sell offer date that precedes the advance sale date.

A purchaser of the futures contract may have a right to sell the futures contract to another party, such as the entity (e.g., publisher) who initially sold the futures contract to the purchaser. Accordingly, the purchaser may essentially serve as a sales agent for the initial seller of the futures contract. Market conditions may enable the purchaser to sell the futures contract at a premium, though conditions may be placed on the right of the purchaser to sell the futures contract.

### II. Example Embodiments for Monetizing Page Views on an Exchange Using Futures Contracts

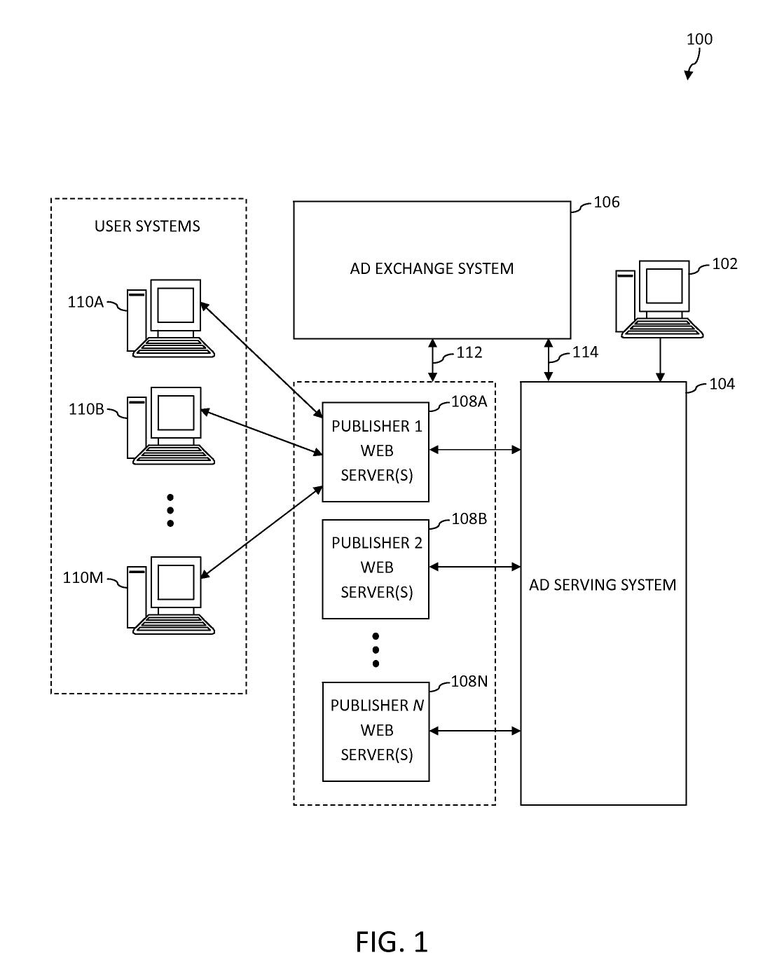

FIG. 1 is a block diagram of an example online ad system 100 in accordance with an embodiment described herein. Generally speaking, online ad system 100 operates to serve online ads provided by advertisers to Web sites published by publishers when such Web sites are accessed by certain users of the network, thereby delivering the online ads to the users. As shown in FIG. 1, online ad system 100 includes at least one advertiser system 102, an ad serving system 104, an ad exchange system 106, a plurality of publisher Web servers 108A-108N, and a plurality of user systems 110A-110M.

Each of publisher Web servers 108A-108N is a computer or other processing system that includes one or more processors configured to host a Web site published by a corresponding publisher 1-N so that such Web site is accessible to users of network 100. A user may access such Web sites using a client (e.g., a Web browser) installed on a system owned by or otherwise accessible to the user. By way of example, FIG. 1 shows a plurality of user systems 110A-110M. Each of user systems 110A-110M is a computer or other processing system including one or more processors configured to execute a client that enables a user to visit any of the Web sites hosted by publisher Web servers 108A-108N. As depicted in FIG. 1, each of client systems 110A-110M is communicatively connected to publisher 1 Web server(s) 108A for the purpose of accessing a Web site published by publisher 1. Persons skilled in the relevant art(s) will recognize that each of user systems 110A-110M is capable of connecting to any of publisher Web servers 108A-108N to access the Web sites hosted thereon. Communication between user systems 110A-110M and publisher Web servers 108A-108N is carried out over a wide area network, such as the Internet, using well-known network communication protocols. Additionally or alternatively, the communication may be carried out over a local area network (LAN) or another type of network.

Advertiser system 102 is a computer or other processing system that includes one or more processors configured to upload online ads and/or creative assets to ad serving system 104. Examples of creative assets include but are not limited to video files, audio files, image files, etc. Such creative assets may be incorporated into online ads by ad serving system 104.

Ad serving system 104 is a computer or other processing system including one or more processors configured to deliver online ads to each of publisher Web servers 108A-108N when the Web sites hosted by such Web servers are accessed by certain users, thereby facilitating the delivery of such online ads to the users. Ad serving system 104 delivers the online ads in accordance with instructions received from ad exchange system 106. For example, ad serving system 104 may receive the online ads from an advertiser system 102. In another example, ad serving system 104 may generate the online ads based on one or more creative assets received from the advertiser system 102.

Ad exchange system 106 is a computer or other processing system including one or more processors configured to monetize page views using an ad exchange. An ad exchange is a technology platform through which page views (a.k.a. page impressions) may be sold to online advertisers. Example ad exchanges include but are not limited to Rights Media Exchange (RMX) owned by Yahoo! Inc.; AdECN owned by Microsoft Corporation; Double Click Ad Exchange owned by DoubleClick, a subsidiary of Google Inc.; ADSDAQ Exchange owned by ContextWeb, Ltd.; etc.

Publisher Web servers 108A-108N are communicatively coupled to ad exchange system 106 via link 112, and ad serving system 104 is communicatively coupled to ad exchange system 106 via link 114. Publisher Web servers 108A-108N provide sell requests to ad exchange system 106 via link 112, requesting that ad exchange system 106 sell respective inventory (i.e., page views regarding respective Web pages) in accordance with terms specified in the sell requests. Ad serving system provides purchase request(s) to ad exchange system 106 via link 114, requesting that ad exchange system 106 purchase page views for placement of ads in accordance with terms specified in the purchase request(s).

Ad exchange system 106 is capable of conducting sale transactions with respect to page views for placement of ads based on the terms specified in the sell requests received from publisher Web servers 108A-108N and the purchase request(s) received from ad serving system 104. The terms may take into account any of a variety of factors, including but not limited to relevance between Web page content associated with the page views and content of the ads, a pricing model specified by a sell request or a purchase request, etc. For example, a sell request may specify ad content that is acceptable or unacceptable with respect to a corresponding page view. In another example, a purchase request may specify Web page content that is acceptable or unacceptable with respect to a corresponding ad. In yet another example, the terms may specify that a sale transaction regarding a page view or an ad is to be performed in accordance with an auction pricing model, a dynamic pricing model, a limit pricing model, another pricing model, or some combination thereof.

An auction pricing model is a pricing model in which a page view is sold to the highest bidder. A dynamic pricing model is a pricing model in which the goals (e.g., return on investment (ROI) goals) of a publisher or an advertiser are taken into account to determine an offer price or a bid price, respectively, with respect to a page view. A limit pricing model is a pricing model in which a publisher sets a minimum offer price with respect to a page view or an advertiser sets a maximum bid price with respect to the page view.

Ad exchange system 106 provides instructions to ad serving system 104 via link 114, indicating which ads are to be served with respect to the page views. Ad serving system 104 serves the ads with respect to the page views in accordance with the instructions received from ad exchange system 106 in response to notifications from publisher Web servers 108A-108N that the Web pages corresponding to the respective page views are accessed by user system 110A-110M.

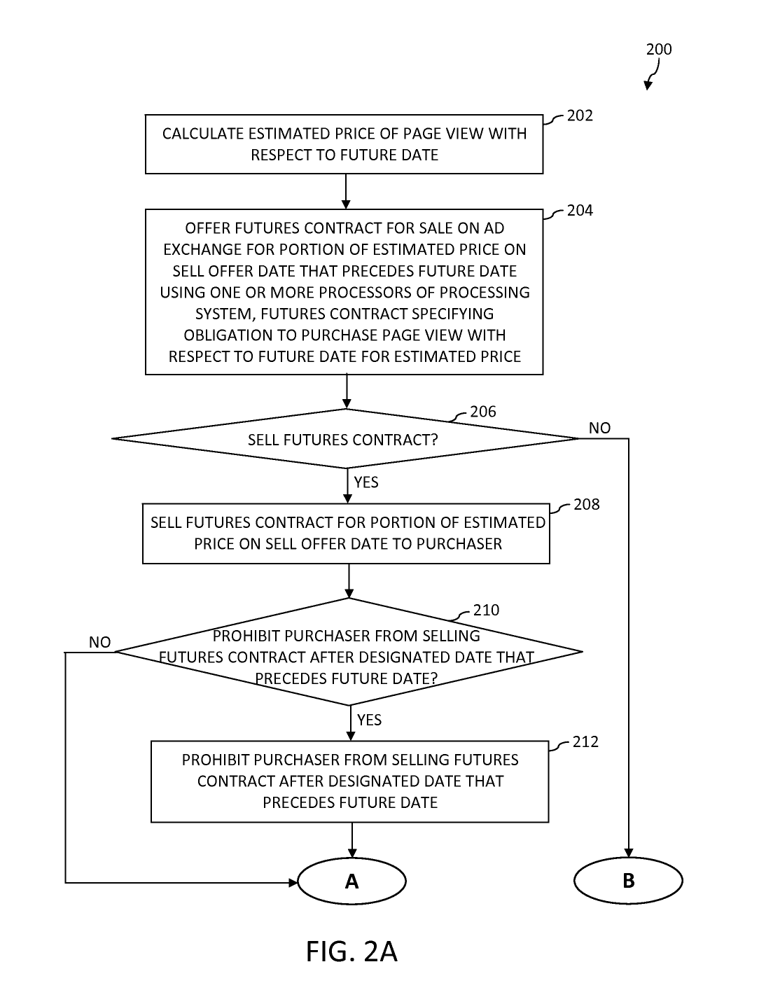

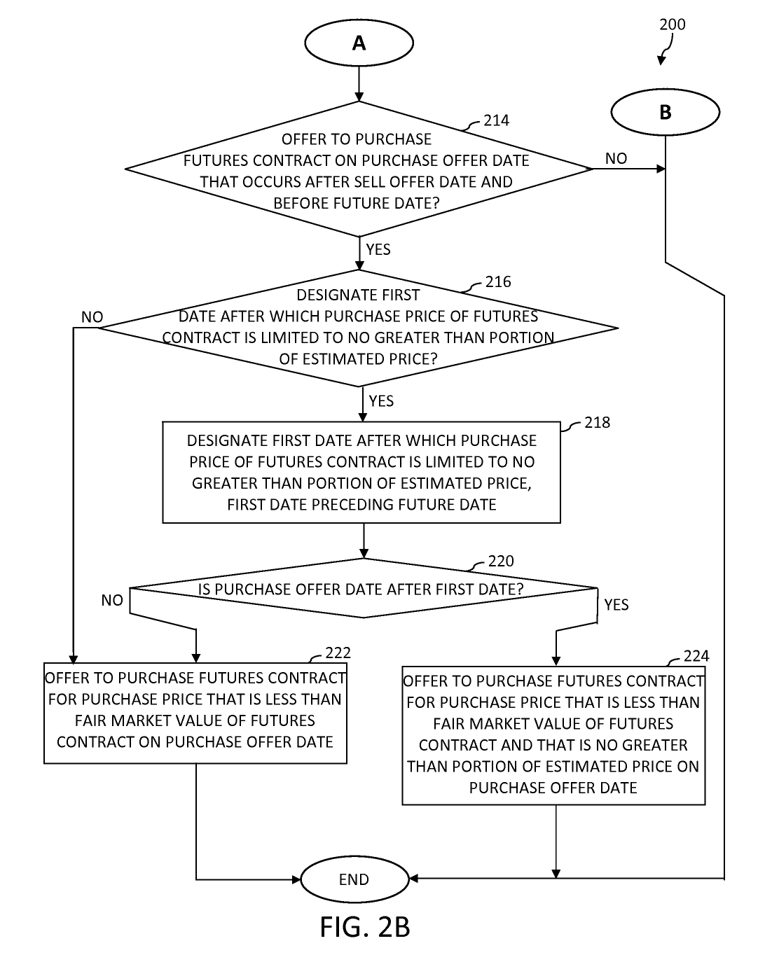

In accordance with example embodiments, ad exchange system 106 is capable of monetizing page views using futures contracts. For example, ad exchange system 106 may be configured to calculate an estimated price of a page view with respect to a future date. In accordance with this example, ad exchange system 106 may be further configured to offer a futures contract for sale on an ad exchange for a portion of the estimated price on a sell offer date that precedes the future date. In another example, ad exchange system 106 may be configured to designate an advance sale date on which a page view is to be offered for sale for a designated price. In accordance with this example, the advance sale date precedes an occurrence date on which the page view is to occur. In further accordance with this example, ad exchange system 106 may offer a futures contract for sale on an ad exchange for a portion of the designated price on a sell offer date that precedes the advance sale date. Techniques for monetizing page views on an exchange using futures contracts are discussed in further detail below with reference to FIGS. 2A-2B, 3-8, 9A-9B, 10, and 11.

Communication among advertiser system 102, ad serving system 104, ad exchange system 106, and publisher Web servers 108A-108N is carried out over a wide area network, such as the Internet, using well-known network communication protocols. Additionally or alternatively, the communication may be carried out over a local area network (LAN) or another type of network. Although one advertiser system 102 is depicted in FIG. 1, persons skilled in the relevant art(s) will recognize that any number of advertiser systems may be communicatively coupled to ad serving system 104. For instance, the functionality of ad serving system 104 may be accessible to one or more advertisers or representatives thereof via respective advertiser systems.

Although advertiser system 102 and user systems 110A-110M are depicted as desktop computers in FIG. 1, persons skilled in the relevant art(s) will appreciate that advertiser system 102 and user systems 110A-110M may include any client-enabled system or device, including but not limited to a laptop computer, a personal digital assistant, a cellular telephone, or the like.

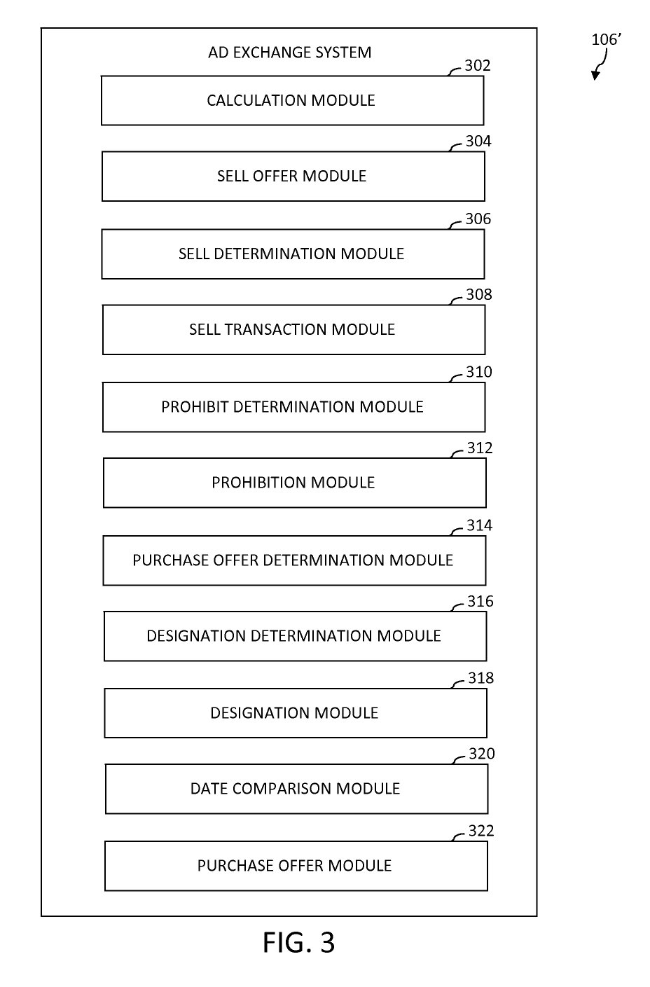

FIGS. 2A and 2B depict respective portions of a flowchart 200 of a method for monetizing a page view on an ad exchange using a futures contract in accordance with an embodiment described herein. Flowchart 200 may be performed by ad exchange system 106 of online ad system 100 shown in FIG. 1, for example. For illustrative purposes, flowchart 200 is described with respect to an ad exchange system 106′ shown in FIG. 3, which is an example of an ad exchange system 106, according to an embodiment. In this document, whenever a prime is used to modify a reference number, the modified reference number indicates an example (or alternate) implementation of the element that corresponds to the reference number.

As shown in FIG. 3, ad exchange system 106′ includes a calculation module 302, a sell offer module 304, a sell determination module 306, a sell transaction module 308, a prohibit determination module 310, a prohibition module 312, a purchase offer determination module 314, a designation determination module 316, a designation module 318, a date comparison module 320, and a purchase offer module 322. Further structural and operational embodiments will be apparent to persons skilled in the relevant art(s) based on the discussion regarding flowchart 200. Flowchart 200 is described as follows.

As shown in FIG. 2A, the method of flowchart 200 begins at step 202. In step 202, an estimated price of a page view is calculated with respect to a future date. The estimated price of the page view may be calculated using any of a variety of techniques. For instance, an extrapolation technique, such as linear extrapolation, polynomial extrapolation, French curve extrapolation, etc. may be used to calculate the estimated price. In accordance with example embodiments, the estimated price represents a price at which the page view is to be offered for sale, and the future date represents a date on which the page view is scheduled to occur. The estimated price may be based on any of a variety of factors, including but not limited to the popularity of the Web page with which the page view is associated, historical prices of page views regarding the Web page, the duration of time until occurrence of the future date, other market factors and/or trends, etc. In an example implementation, calculation module 302 calculates the estimated price.

At step 204, a futures contract is offered for sale on an ad exchange for a portion of the estimated price on a sell offer date that precedes the future date using one or more processors of a processing system. The futures contract specifies an obligation to purchase the page view with respect to the future date for the estimated price. The portion of the estimated price may be based on any of the factors that may influence the estimated price of the corresponding page view, historical prices of futures contracts regarding page views that are associated with a Web page corresponding to the futures contract, etc. In an example implementation, sell offer module 304 offers the futures contract for sale.

At step 206, a determination is made whether to sell the futures contract. For instance, the determination may be based on whether a purchaser accepts the offer for sale of the futures contract. In an example implementation, sell determination module 306 determines whether to sell the futures contract. If the futures contract is to be sold, flow continues to step 308. Otherwise, flowchart 200 ends.

At step 208, the futures contract is sold for the portion of the estimated price on the sell offer date to a purchaser. In an example embodiment, sell transaction module 308 sells the futures contract.

At step 210, a determination is made whether to prohibit the purchaser from selling the futures contract after a designated date that precedes the future date. For example, selling the futures contract after the designated date may hinder the ability of the publisher of the Web page that is associated with the page view to place ad(s) with respect to the page view. In another example, selling the futures contract back to the initial seller of the futures contract after the designated date may jeopardize the ability of the initial seller to re-sell the futures contract before the future date or to obtain fair market value for the futures contract. In an example implementation, prohibit determination module 310 determines whether to prohibit the purchaser from selling the futures contract after a designated date that precedes the future date. If the purchaser is to be prohibited from selling the futures contract after a designated date that precedes the future date, flow continues to step 212. Otherwise, flow continues to step 214, which is shown in FIG. 2B.

At step 212, the purchaser is prohibited from selling the futures contract after a designated that precedes the future date. In an example implementation, prohibition module 312 prohibits the purchaser from selling the futures contract after the designated date that precedes the future date.

At step 214, a determination is made whether to offer to purchase the futures contract on a purchase offer date that occurs after the sell offer date and before the future date. For instance, the determination may be based on market conditions regarding the futures contract (e.g., fair market value of the futures contract), open interest regarding the futures contract, whether a request is received from a purchaser of the futures contract for the initial seller of the futures contract to purchase the futures contract back from the purchaser, or any of a variety of other suitable factors. In an example implementation, purchase offer determination module 314 determines whether to offer to purchase the futures contract on a purchase offer date that occurs after the sell offer date and before the future date. If an offer is to made to purchase the futures contract on a purchase offer date that occurs after the sell offer date and before the future date, flow continues to step 216. Otherwise, flowchart 200 ends.

At step 216, a determination is made whether a first date is to be designated after which a purchase price of the futures contract is limited to no greater than the portion of the estimated price. For example, designating the first date may dissuade a purchaser of the futures contract from selling the futures contract after the first date. In another example, designating the first date may increase the likelihood that the initial seller of the futures contract will be able to profit from a subsequent sale of the futures contract. For instance, as the future date draws near, it may be more difficult for the initial seller of the futures contract to find another purchaser who is willing to pay fair market value for the futures contract. In an example implementation, designation determination module 316 determines whether a first date is to be designated after which the purchase price of the futures contract is limited to no greater than the portion of the estimated price. If a first date after which the purchase price of the futures contract is limited to no greater than the portion of the estimated price is to be designated, flow continues to step 218. Otherwise, flow continues to step 222.

At step 218, a first date after which the purchase price of the futures contract is limited to no greater than the portion of the estimated price is designated. The first date precedes the future date. In an example implementation, designation module 318 designates the first date.

At step 220, a determination is made whether the purchase offer date is after the first date. In an example implementation, date comparison module 320 determines whether the purchase offer date is after the first date. If the purchase offer date is after the first date, flow continues to step 224. Otherwise, flow continues to step 222.

At step 222, an offer is made to purchase the futures contract for a purchase price that is less than a fair market value of the futures contract on the purchase offer date. For example, if the fair market value of the futures contract has increased twenty percent above the portion of the estimated price that was paid by the purchaser of the futures contract at step 208, an offer may be made to purchase the futures contract for a ten percent premium above the portion of the estimated price that was paid by the purchaser. In accordance with this example, the purchaser profits by ten percent, and the initial seller of the futures contract may resell the futures contract at the increased fair market value. In an example implementation, purchase offer module 222 offers to purchase the futures contract for the purchase price that is less than the fair market value of the futures contract on the purchase offer date.

At step 224, an offer is made to purchase the futures contract for a purchase price that is less than the fair market value of the futures contract and that is no greater than the portion of the estimated price on the purchase offer date. For example, the purchaser of the futures contract may forfeit an opportunity to obtain a profit with respect to a higher fair market value of the futures contract if the purchaser waits until after the first date to sell the futures contract back to the initial seller of the futures contract. In an example implementation, purchase offer module 222 offers to purchase the futures contract for the purchase price that is less than the fair market value of the futures contract and that is no greater than the portion of the estimated price on the purchase offer date.

In some example embodiments, one or more steps 202, 204, 206, 208, 210, 212, 214, 216, 218, 220, 222, and/or 224 of flowchart 200 may not be performed. Moreover, steps in addition to or in lieu of steps 202, 204, 206, 208, 210, 212, 214, 216, 218, 220, 222, and/or 224 may be performed.

It will be recognized that ad exchange system 106′ may not include one or more of calculation module 302, sell offer module 304, sell determination module 306, sell transaction module 308, prohibit determination module 310, prohibition module 312, purchase offer determination module 314, designation determination module 316, designation module 318, date comparison module 320, and/or purchase offer module 322. Furthermore, ad exchange system 106′ may include modules in addition to or in lieu of calculation module 302, sell offer module 304, sell determination module 306, sell transaction module 308, prohibit determination module 310, prohibition module 312, purchase offer determination module 314, designation determination module 316, designation module 318, date comparison module 320, and/or purchase offer module 322.

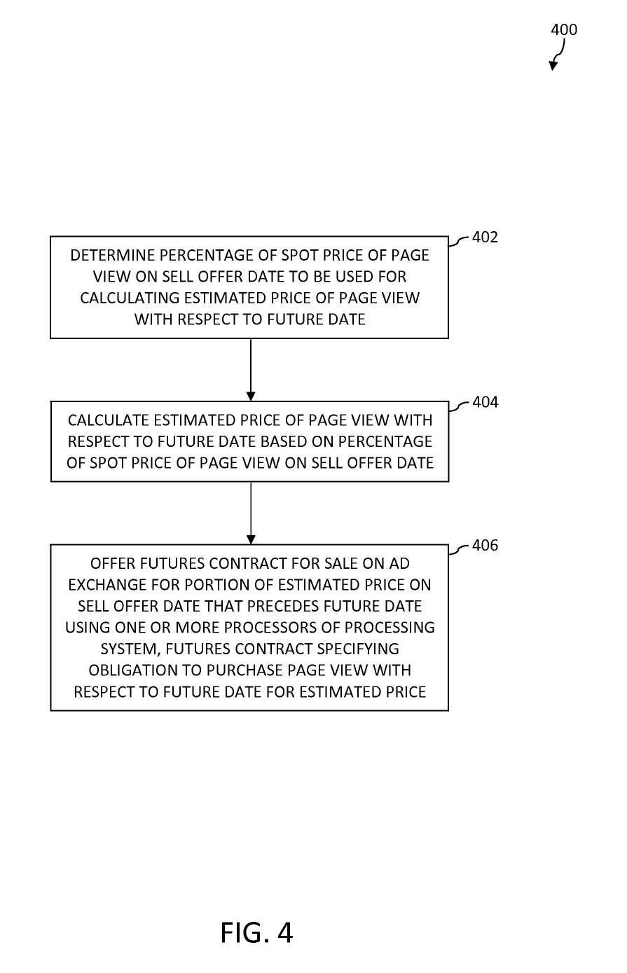

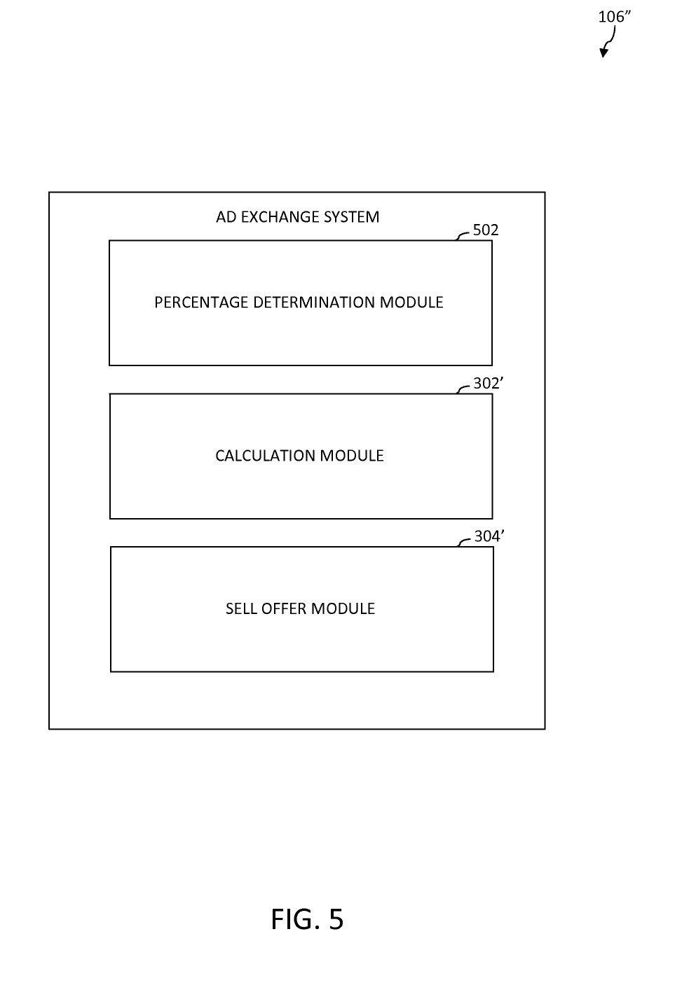

FIG. 4 depicts a flowchart 400 of a method for monetizing a page view on an ad exchange using a futures contract in accordance with an embodiment described herein. Flowchart 400 may be performed by ad exchange system 106 of online ad system 100 shown in FIG. 1, for example. For illustrative purposes, flowchart 400 is described with respect to an ad exchange system 106″ shown in FIG. 5, which is an example of an ad exchange system 106, according to an embodiment. As shown in FIG. 5, ad exchange system 106″ includes a percentage determination module 502, a calculation module 302′, and a sell offer module 304′. Further structural and operational embodiments will be apparent to persons skilled in the relevant art(s) based on the discussion regarding flowchart 400. Flowchart 400 is described as follows.

As shown in FIG. 4, the method of flowchart 400 begins at step 402. In step 402, a percentage of a spot price of a page view on a sell offer date is determined. The percentage of the spot price is to be used for calculating an estimated price of the page view with respect to a future date. For example, the percentage of the spot price may be an established percentage (e.g., 1%, 2.5%, etc.) that does not take into account market conditions regarding the page view. In another example, the percentage of the spot price may be based on market conditions, such as open interest regarding the futures contract. In an example implementation, percentage determination module 502 determines the percentage of the spot price of the page view on the sell offer date.

At step 404, an estimated price of the page view is calculated with respect to the future date based on the percentage of the spot price of the page view on the sell offer date. In an example implementation, calculation module 302′ calculates the estimated price.

At step 406, a futures contract is offered for sale on an ad exchange for a portion of the estimated price on the sell offer date that precedes the future date using one or more processors of a processing system. The futures contract specifies an obligation to purchase the page view with respect to the future date for the estimated price. In an example implementation, sell offer module 304′ offers the futures contract for sale.

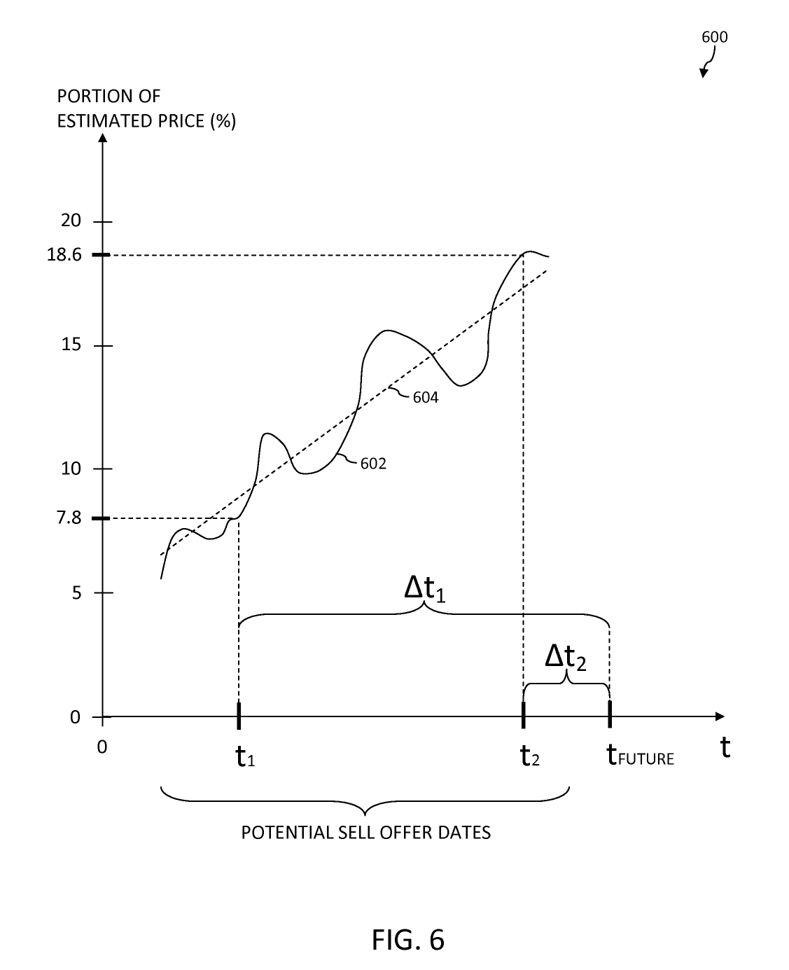

FIG. 6 is a graphical representation 600 of an example relationship between a sell offer price of a futures contract regarding a page view and time in accordance with an embodiment described herein. The Y-axis of graphical representation 600 represents the sell offer price of the futures contract. The sell offer price is shown as a portion of the estimated price of the page view for illustrative purposes. The X-axis of graphical representation 600 represents time. Curve 602 is an example plot of the sell offer price of the futures contract with respect to time.

Line 604 is a linear approximation of curve 602 to illustrate a general trend of the sell offer price with respect to time. In particular, line 604 indicates that the sell offer price is inversely proportional to the duration of time between the sell offer date and the future date t_{FUTURE} on which the page view is to occur. For example, the sell offer price is shown to be equal to 7.8 percent of the estimated price of the page view on a first sell offer date t₁. The duration of time between the first sell offer date t₁ and the future date t_{FUTURE} is represented as Δt₁. The sell offer price is shown to be equal to 18.6 percent of the estimated price of the page view on a second sell offer date t₂ that is after the first sell offer date t₁l. The duration of time between the second sell offer date t₂ and the future date t_{FUTURE} is represented as Δt₂. In accordance with the inverse proportionality described above, the sell offer price on the first sell offer date t₁, which precedes the future date t_{FUTURE} by the time period Δt₁, is less than the sell offer price on the second sell offer date t₂, which precedes the future date t_{FUTURE} by the time period Δt₂.

Graphical representation 600 is provided for illustrative purposes and is not intended to be limiting. For instance, it will be recognized that the sell offer price of a futures contract regarding a page view need not necessarily be inversely proportional to the duration of time between the sell offer date and the future date t_{FUTURE} on which the page view is to occur.

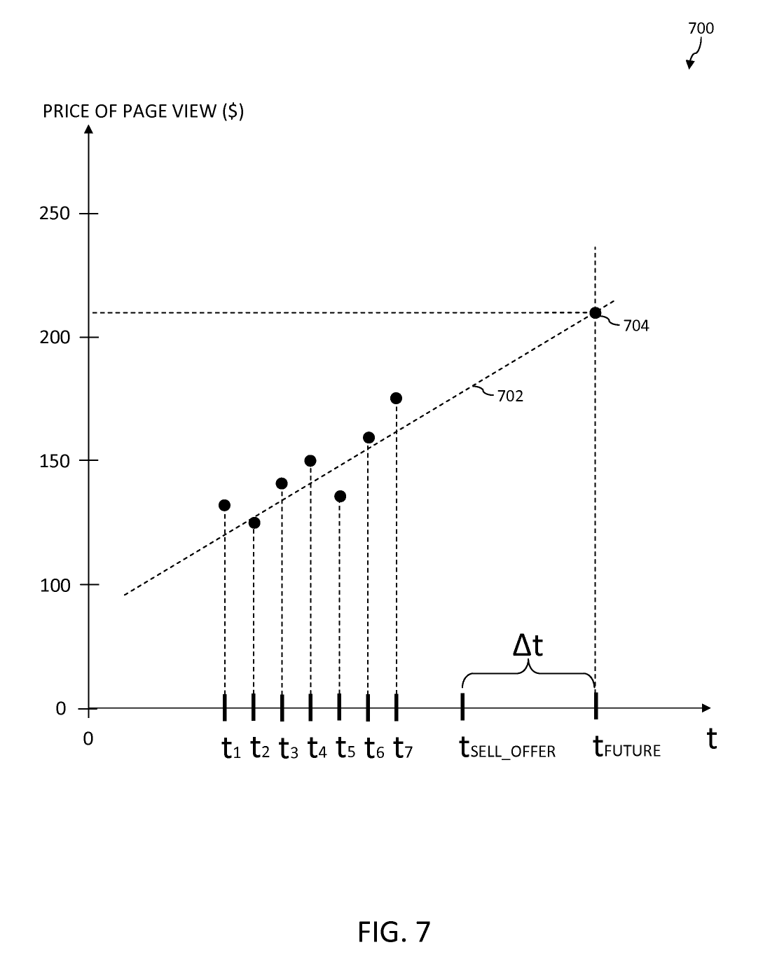

FIG. 7 is a graphical representation 700 of an example technique for calculating an estimated price 704 of a page view with respect to a future date t_{FUTURE} in accordance with an embodiment described herein. The Y-axis of graphical representation 700 represents the price of the page view, and the X-axis represents time. A plurality of spot prices of the page view corresponding to a plurality of respective dates t₁-t₇ are shown in FIG. 7 for illustrative purposes. A spot price of the page view with respect to a designated date is a current price (as opposed to a futures price) of the page view on the designated date. Line 702 is a linear approximation of the plurality of spot prices of the page view corresponding to the plurality of respective dates t₁-t₇.

An extrapolation technique is used to calculate the estimated price 704 of the page view with respect to the future date t_{FUTURE} based on the plurality of spot prices of the page view corresponding to the plurality of respective dates t₁-t₇. It should be noted that the plurality of respective dates t₁-t₇ precedes a sell offer date t_{SELL}_{_{—}}_{OFFER} on which a futures contract regarding the page view is to be offered for sale. The sell offer date t_{SELL}_{_{—}}_{OFFER} precedes the future date t_{FUTURE} by a duration of time Δt. For example, the duration of time Δt may be a designated number of days, weeks, months, or years (e.g., approximately one year, approximately one-and-a-half years, etc.).

Seven spot prices of the page view are shown in FIG. 7 to be used for calculating the estimated price 704 of the page view with respect to the future date t_{FUTURE} for illustrative purposes and are not intended to be limiting. For instance, any suitable number of spot prices of the page view may be used to calculate the estimated price 704 of the page view with respect to the future date T_{FUTURE}.

Graphical representation 700 is provided for illustrative purposes and is not intended to be limiting. For instance, it will be recognized that the sell offer price of a futures contract regarding a page view need not necessarily be inversely proportional to the duration of time between the sell offer date and the future date t_{FUTURE} on which the page view is to occur.

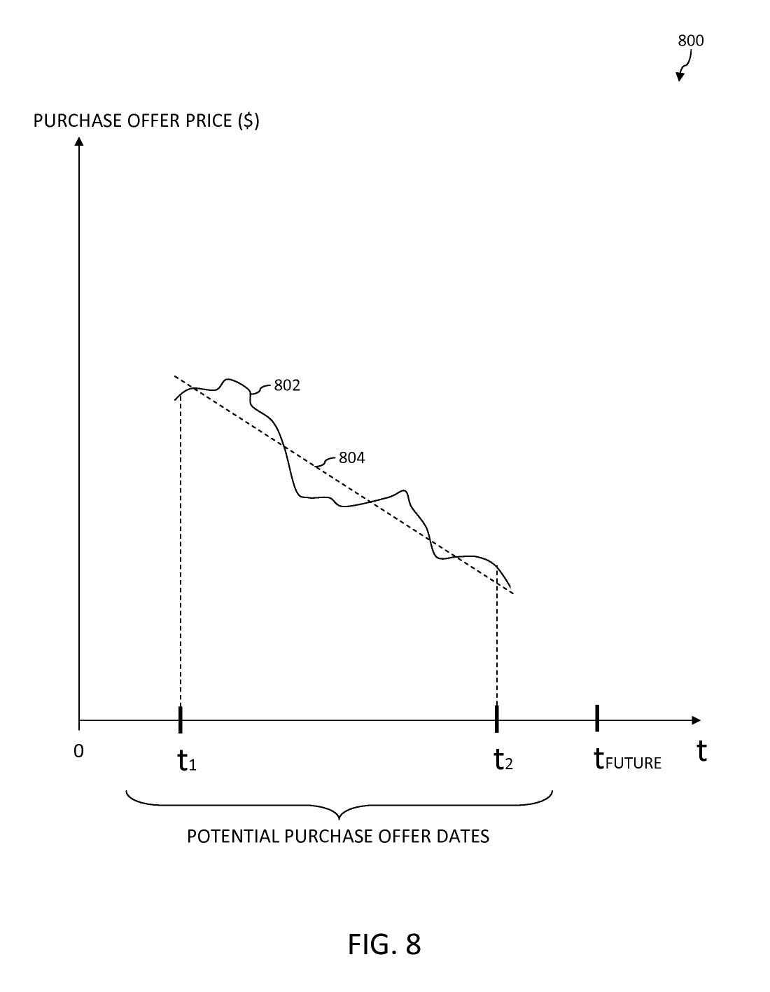

FIG. 8 is a graphical representation 800 of an example relationship between a purchase offer price of a futures contract regarding a page view and time in accordance with an embodiment described herein. The Y-axis of graphical representation 800 represents the purchase offer price, and the X-axis represents time. Curve 802 is an example plot of the purchase offer price of the futures contract with respect to time.

Line 804 is a linear approximation of curve 802 to illustrate a general trend of the purchase offer price with respect to time. In particular, line 804 indicates that the purchase offer price is directly proportional to the duration of time between the purchase offer date and the future date t_{FUTURE} on which the page view is to occur. For instance, the purchase offer price decreases as the purchase offer date nears the future date T_{FUTURE}.

Graphical representation 800 is provided for illustrative purposes and is not intended to be limiting. For instance, it will be recognized that the purchase offer price of a futures contract regarding a page view need not necessarily be directly proportional to the duration of time between the purchase offer date and the future date t_{FUTURE} on which the page view is to occur.

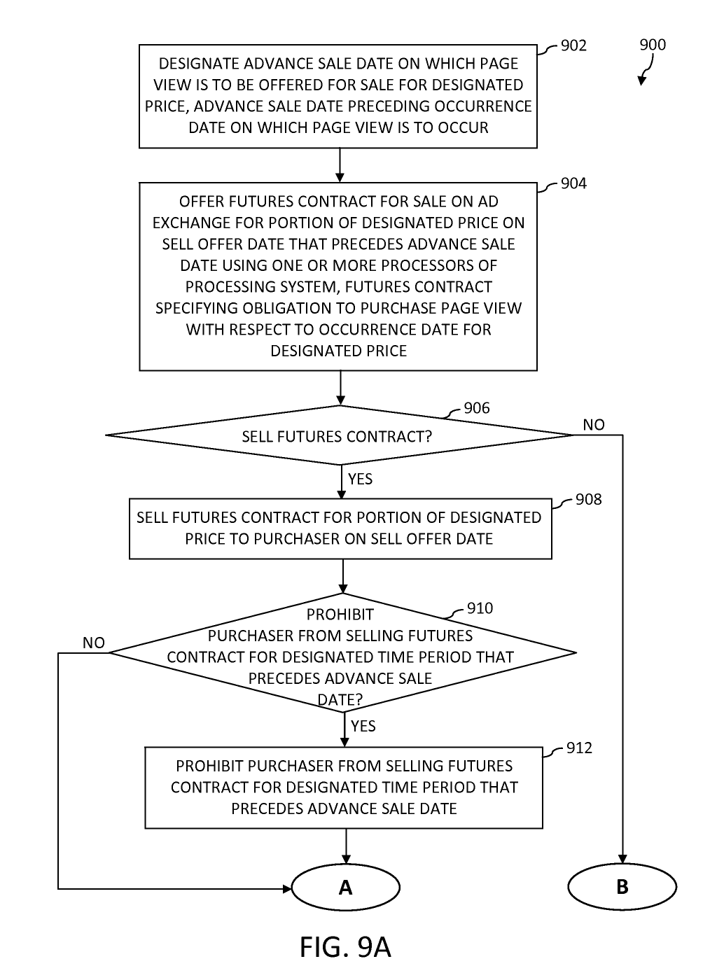

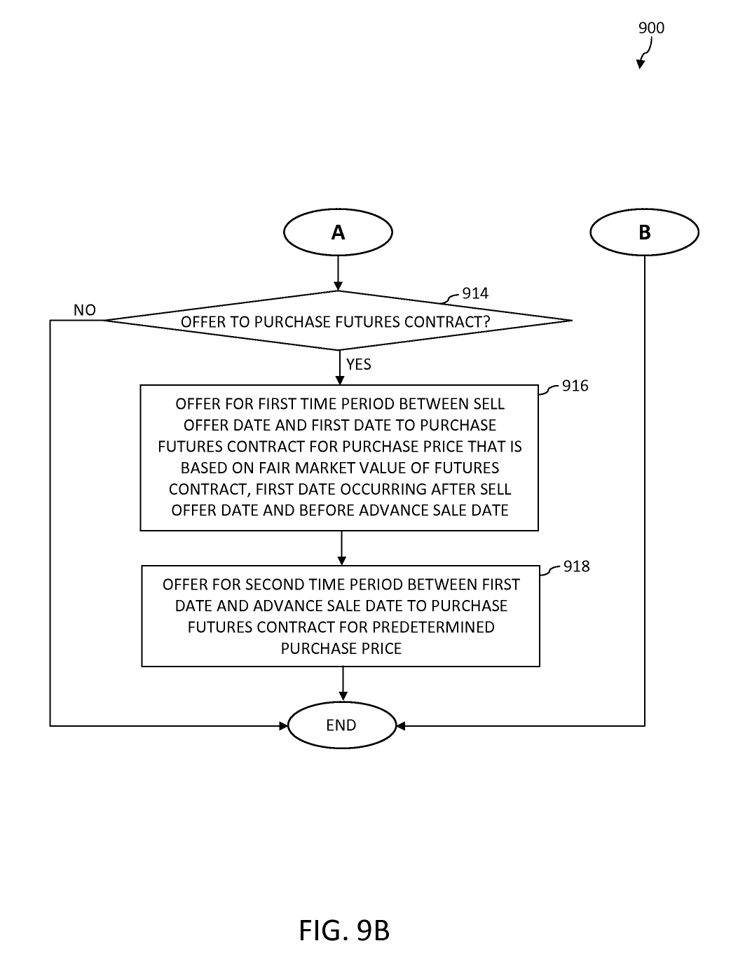

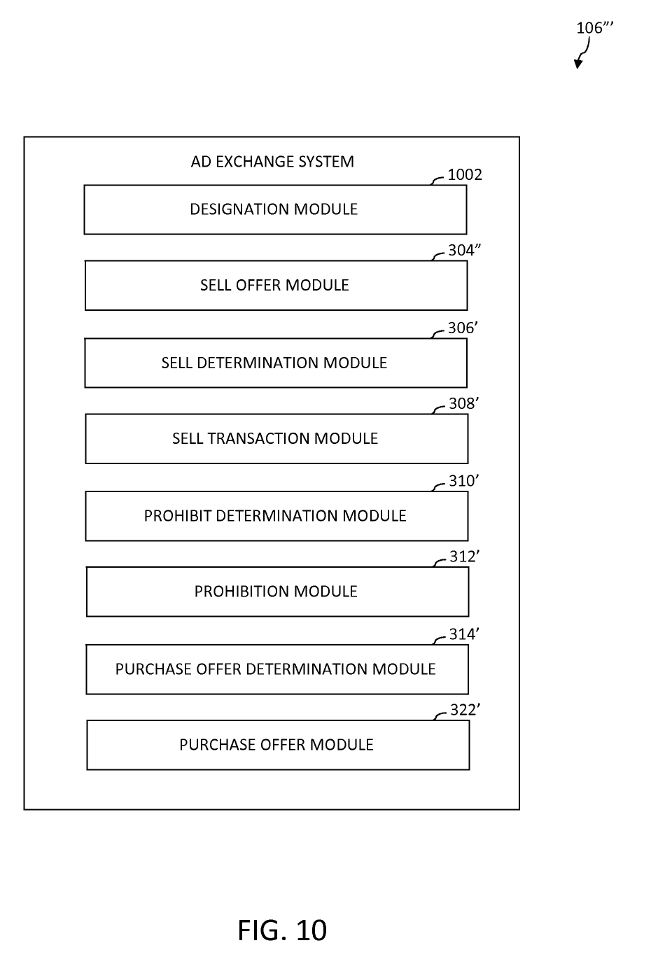

FIGS. 9A and 9B depict respective portions of a flowchart 900 of a method for monetizing a page view on an ad exchange using a futures contract in accordance with an embodiment described herein. Flowchart 900 may be performed by ad exchange system 106 of online ad system 100 shown in FIG. 1, for example. For illustrative purposes, flowchart 900 is described with respect to an ad exchange system 106′″ shown in FIG. 10, which is an example of an ad exchange system 106, according to an embodiment.

As shown in FIG. 10, ad exchange system 106′″ includes a designation module 1002, a sell offer module 304″, a sell determination module 306′, a sell transaction module 308′, a prohibit determination module 310′, a prohibition module 312′, a purchase offer determination module 314′, and a purchase offer module 322′. Further structural and operational embodiments will be apparent to persons skilled in the relevant art(s) based on the discussion regarding flowchart 900. Flowchart 900 is described as follows.

As shown in FIG. 9A, the method of flowchart 900 begins at step 902. In step 902, an advance sale date is designated on which a page view is to be offered for sale for a designated price. The advance sale date precedes an occurrence date on which the page view is to occur. In an example implementation, designation module 1002 designates the advance sale date.

At step 904, a futures contract is offered for sale on an ad exchange for a portion of the designated price on a sell offer date that precedes the advance sale date using one or more processors of a processing system. The futures contract specifies an obligation to purchase the page view with respect to the occurrence date for the designated price. In an example implementation, sell offer module 1004 offers the futures contract for sale on the ad exchange.

At step 906, a determination is made whether to sell the futures contract. In an example implementation, sell determination module 1006 determines whether to sell the futures contract.

At step 908, the futures contract is sold for the portion of the designated price to a purchaser on the sell offer date. In an example implementation, sell transaction module 1008 sells the futures contract.

At step 910, a determination is made whether to prohibit the purchaser from selling the futures contract for a designated time period that precedes the advance sale date. In an example implementation, prohibit determination module 1010 determines whether to prohibit the purchaser from selling the futures contract for a designated time period that precedes the advance sale date. If the purchaser is to be prohibited from selling the futures contract for a designated time period that precedes the advance sale date, flow continues to step 912. Otherwise, flow continues to step 914, which is shown in FIG. 9B.

At step 912, the purchaser is prohibited from selling the futures contract for a designated time period that precedes the advance sale date. In an example implementation, prohibition module 1012 prohibits the purchaser from selling the futures contract for a designated period that precedes the advance sale date.

At step 914, a determination is made whether to offer to purchase the futures contract. In an example implementation, purchase offer determination module 1014 determines whether to offer to purchase the futures contract. If an offer is to be made to purchase the futures contract, flow continues to step 916. Otherwise, flowchart 900 ends.

At step 916, an offer is made for a first time period between the sell offer date and a first date to purchase the futures contract for a purchase price that is based on a fair market value of the futures contract. The first date occurs after the sell offer date and before the advance sale date. In an example implementation, purchase offer module 1016 offers for the first time period to purchase the futures contract for the purchase price that is based on the fair market value of the futures contract.

At step 918, an offer is made for a second time period between the first date and the advance sale date to purchase the futures contract for a predetermined purchase price. For instance, the predetermined purchase price may be a specified percentage of the portion of the designated price for which the futures contract was sold to the purchaser at step 908, a predetermined percentage of the designated price, or any other suitable price. In an example implementation, purchase offer module 1016 offers for the second time period to purchase the futures contract for the predetermined purchase price.

In some example embodiments, one or more steps 902, 904, 906, 908, 910, 912, 914, 916, and/or 918 of flowchart 900 may not be performed. Moreover, steps in addition to or in lieu of steps 902, 904, 906, 908, 910, 912, 914, 916, and/or 918 may be performed.

It will be recognized that ad exchange system 106″ may not include one or more of designation module 1002, sell offer module 304″, sell determination module 306′, sell transaction module 308′, prohibit determination module 310′, prohibition module 312′, purchase offer determination module 314′, and/or purchase offer module 322′. Furthermore, ad exchange system 106″ may include modules in addition to or in lieu of designation module 1002, sell offer module 304″, sell determination module 306′, sell transaction module 308′, prohibit determination module 310′, prohibition module 312′, purchase offer determination module 314′, and/or purchase offer module 322′.

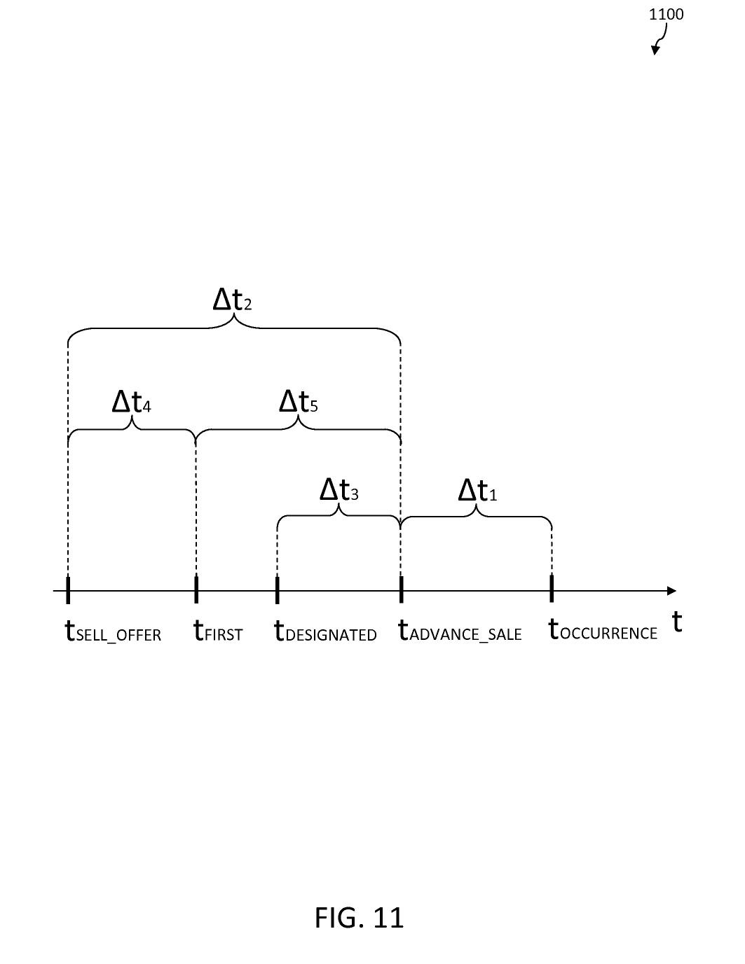

FIG. 11 depicts a timeline 1100 showing example relationships between respective dates regarding monetization of a page view on an ad exchange using a futures contract in accordance with an embodiment described herein. As shown in FIG. 11, the advance sale date t_{ADVANCE}_{_{—}}_{SALE} on which the page view is to be offered for sale precedes the occurrence date t_{OCCURRENCE} on which the page view is to occur by a first duration of time Δt₁. The sell offer date t_{SELL}_{_{—}}_{OFFER} on which the futures contract regarding the page view is to be offered for sale precedes the advance sale date t_{ADVANCE}_{_{—}}_{SALE} by a second duration of time Δt₂. For example, the first duration of time Δt₁ and/or the second duration of time Δt₂ may be a designated number of days, weeks, months, etc. In accordance with this example, the first duration of time Δt₁ and/or the second duration of time Δt₂ may be approximately three months, approximately six months, approximately one year, etc.

In accordance with some example embodiments, a purchaser of the futures contract is prohibited from selling the futures contract for a third duration of time Δt₃ that precedes the advance sale date t_{ADVANCE}_{_{—}}_{SALE}. For example, the third duration of time Δt₃ may be a designated number of days, weeks, months, etc. In accordance with this example, the third duration of time Δt₃ may be approximately one month that ends on the advance sale date t_{ADVANCE}_{_{—}}_{SALE}. It will be recognized that the third duration of time Δt₃ need not necessarily end on the advance sale date t_{ADVANCE}_{_{—}}_{SALE}.

In accordance with some example embodiments, the futures contract is sold to a purchaser on the sell offer date t_{SELL}_{_{—}}_{OFFER}. An offer to purchase the futures contract may be made for a fourth duration of time Δt₄ between the sell offer date t_{SELL}_{_{—}}_{OFFER} and a first date t_{FIRST} that occurs after the sell offer date t_{SELL}_{_{—}}_{OFFER}. An offer to purchase the futures contract may be made for a fifth duration of time Δt₅ between the first date t_{FIRST} and advance sale date t_{ADVANCE}_{_{—}}_{SALE}. For example, a purchase price specified by the offer that is made for the fourth duration of time Δt₄ may be based on a fair market value of the futures contract. In accordance with this example, a purchase price specified by the offer that is made for the fifth duration of time Δt₅ may be a predetermined purchase price. In another example, the fifth duration of time Δt₅ may be a designated number of days, weeks, months, etc. In accordance with this example, the fifth duration of time Δt₅ may be approximately one month.

### III. Example Computer Implementation

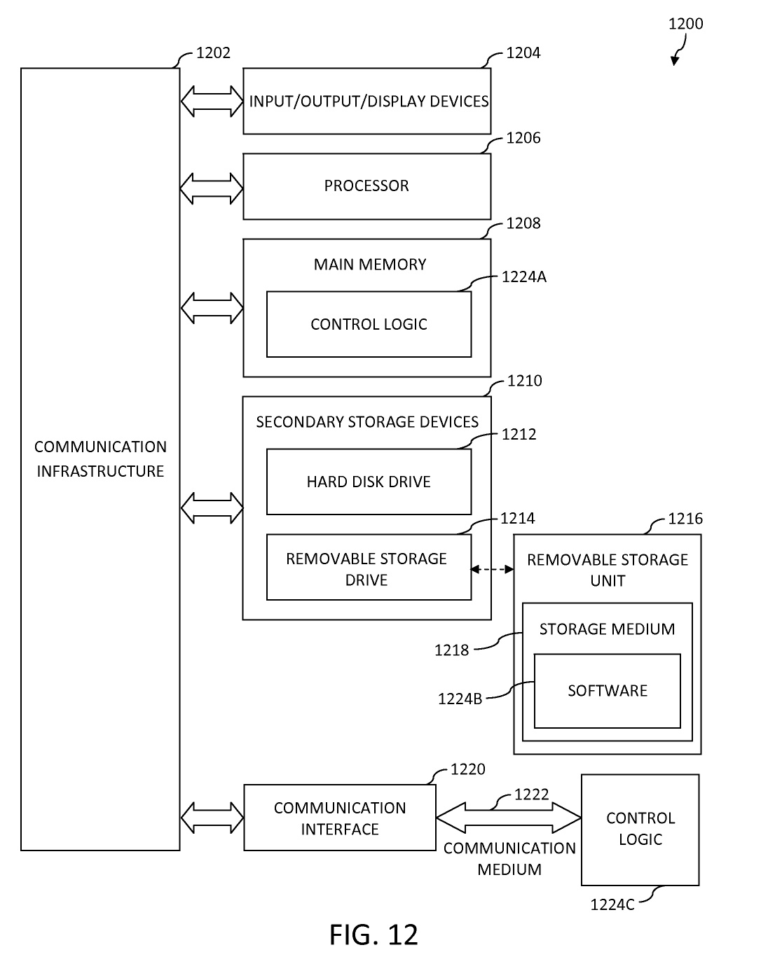

The embodiments described herein, including systems, methods/processes, and/or apparatuses, may be implemented using well known servers/computers, such as computer 1200 shown in FIG. 12. For example, elements of example online ad system 100, including advertiser system 102, ad serving system 104, any of the publisher Web servers 108A-108N, and any of the user systems 110A-110M depicted in FIG. 1, ad exchange system 106 depicted in FIGS. 1, 3, 5, and 10 and elements thereof, and each of the steps of flowcharts 200, 400, and 900 depicted in respective FIGS. 2A-2B, 4, and 9A-9B can each be implemented using one or more computers 1200.

Computer 1200 can be any commercially available and well known computer capable of performing the functions described herein, such as computers available from International Business Machines, Apple, Sun, HP, Dell, Cray, etc. Computer 1200 may be any type of computer, including a desktop computer, a server, etc.

As shown in FIG. 12, computer 1200 includes one or more processors (e.g., central processing units (CPUs)), such as processor 1206. Processor 1206 may include calculation module 302 of FIGS. 3 and 5; sell offer module 304 of FIGS. 3, 5, and 10; sell determination module 306, sell transaction module 308, prohibit determination module 310, prohibition module 312, purchase offer determination module 314, and/or purchase offer module 322 of FIGS. 3 and 10; designation determination module 316, designation module 318, and/or date comparison module 320 of FIG. 3; percentage determination module 502 of FIG. 5; designation module 1002 of FIG. 10; or any portion or combination thereof, for example, though the scope of the embodiments is not limited in this respect. Processor 1206 is connected to a communication infrastructure 1202, such as a communication bus. In some embodiments, processor 1206 can simultaneously operate multiple computing threads.

Computer 1200 also includes a primary or main memory 1208, such as a random access memory (RAM). Main memory has stored therein control logic 1224A (computer software), and data.

Computer 1200 also includes one or more secondary storage devices 1210. Secondary storage devices 1210 include, for example, a hard disk drive 1212 and/or a removable storage device or drive 1214, as well as other types of storage devices, such as memory cards and memory sticks. For instance, computer 1200 may include an industry standard interface, such as a universal serial bus (USB) interface for interfacing with devices such as a memory stick. Removable storage drive 1214 represents a floppy disk drive, a magnetic tape drive, a compact disk drive, an optical storage device, tape backup, etc.

Removable storage drive 1214 interacts with a removable storage unit 1216. Removable storage unit 1216 includes a computer useable or readable storage medium 1218 having stored therein computer software 1224B (control logic) and/or data. Removable storage unit 1216 represents a floppy disk, magnetic tape, compact disc (CD), digital versatile disc (DVD), Blue-ray disc, optical storage disk, memory stick, memory card, or any other computer data storage device. Removable storage drive 1214 reads from and/or writes to removable storage unit 1216 in a well known manner.

Computer 1200 also includes input/output/display devices 1204, such as monitors, keyboards, pointing devices, etc.

Computer 1200 further includes a communication or network interface 1220. Communication interface 1220 enables computer 1200 to communicate with remote devices. For example, communication interface 1220 allows computer 1200 to communicate over communication networks or mediums 1222 (representing a form of a computer useable or readable medium), such as local area networks (LANs), wide area networks (WANs), the Internet, etc. Network interface 1220 may interface with remote sites or networks via wired or wireless connections. Examples of communication interface 1222 include but are not limited to a modem, a network interface card (e.g., an Ethernet card), a communication port, a Personal Computer Memory Card International Association (PCMCIA) card, etc.

Control logic 1224C may be transmitted to and from computer 1200 via the communication medium 1222.

Any apparatus or manufacture comprising a computer useable or readable medium having control logic (software) stored therein is referred to herein as a computer program product or program storage device. This includes, but is not limited to, computer 1200, main memory 1208, secondary storage devices 1210, and removable storage unit 1216. Such computer program products, having control logic stored therein that, when executed by one or more data processing devices, cause such data processing devices to operate as described herein, represent embodiments of the invention.

For example, each of the elements of example ad exchange system 106, including calculation module 302 depicted in FIGS. 3 and 5; sell offer module 304 depicted in FIGS. 3, 5, and 10; sell determination module 306, sell transaction module 308, prohibit determination module 310, prohibition module 312, purchase offer determination module 314, and purchase offer module 322, each depicted in FIGS. 3 and 10; designation determination module 316, designation module 318, and date comparison module 320, each depicted in FIG. 3; percentage determination module 502 depicted in FIG. 5; designation module 1002 depicted in FIG. 10; and each of the steps of flowcharts 200, 400, and 900 depicted in respective FIGS. 2A-2B, 4, and 9A-9B can be implemented as control logic that may be stored on a computer useable medium or computer readable medium, which can be executed by one or more processors to operate as described herein.

The invention can be put into practice using software, hardware, and/or operating system implementations other than those described herein. Any software, hardware, and operating system implementations suitable for performing the functions described herein can be used.

### IV. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method comprising:
calculating an estimated price of a page view with respect to a future date; and
offering a futures contract for sale on an ad exchange for a portion of the estimated price on a sell offer date that precedes the future date using one or more processors of a processing system, the futures contract specifying an obligation to purchase the page view with respect to the future date for the estimated price.

2. The method of claim 1, wherein the estimated price is equal to a spot price of the page view on the sell offer date plus a predetermined percentage of the spot price of the page view on the sell offer date.

3. The method of claim 1, wherein the portion of the estimated price is based on a duration of time between the sell offer date and the future date.

4. The method of claim 3, wherein the portion of the estimated price is inversely proportional to the duration of the time between the sell offer date and the future date.

5. The method of claim 1, wherein the portion of the estimated price is in a range from five percent of the estimated price to fifteen percent of the estimated price.

6. The method of claim 1, wherein calculating the estimated price of the page view comprises:
extrapolating based on a plurality of spot prices of the page view with respect to a plurality of respective dates that precedes the sell offer date to calculate the estimated price of the page view with respect to the future date.

7. The method of claim 1, wherein offering the futures contract comprises:
offering the futures contract for sale on the ad exchange for the portion of the estimated price on the sell offer date that precedes the future date by approximately one year.

8. The method of claim 1, wherein offering the futures contract comprises:
offering the futures contract for sale on the ad exchange for the portion of the estimated price on the sell offer date that precedes the future date by approximately one-and-a-half years.

9. The method of claim 1, further comprising:
selling the futures contract for the portion of the estimated price on the sell offer date; and
offering to purchase the futures contract for a purchase price that is less than a fair market value of the futures contract on a purchase offer date that occurs after the sell offer date and before the future date.

10. The method of claim 9, wherein offering to purchase the futures contract comprises:
designating a first date after which the purchase price is limited to no greater than the portion of the estimated price, the first date preceding the future date.

11. The method of claim 9, wherein the purchase price is based on a duration of time between the purchase offer date and the future date.

12. The method of claim 11, wherein the purchase price is directly proportional to the duration of the time between the purchase offer date and the future date.

13. The method of claim 1, further comprising:
selling the futures contract for the portion of the estimated price on the sell offer date to a purchaser; and
prohibiting the purchaser from selling the futures contract after a designated date that precedes the future date.

14. A system comprising:
a calculation module configured to calculate an estimated price of a page view with respect to a future date; and
a sell offer module configured to offer a futures contract for sale on an ad exchange for a portion of the estimated price on a sell offer date that precedes the future date, the futures contract specifying an obligation to purchase the page view with respect to the future date for the estimated price.

15. The system of claim 14, further comprising:
a sell transaction module configured to sell the futures contract for the portion of the estimated price on the sell offer date; and
a purchase offer module configured to offer to purchase the futures contract for a purchase price that is based on a fair market value of the futures contract for a first time period between the sell offer date and a first date that occurs after the sell offer date, the purchase offer module further configured to offer to purchase the futures contract for a predetermined purchase price for a second time period between the first date and a date on which the page view is to be offered for sale.

16. The system of claim 14, further comprising:
a sell transaction module configured to sell the futures contract for the portion of the estimated price on the sell offer date to a purchaser; and
a purchase offer module configured to offer to purchase the futures contract during a time period that precedes a date on which the page view is to be offered for sale, the time period ending a designated duration of time before the date on which the page view is to be offered for sale.

17. A method comprising:
designating an advance sale date on which a page view is to be offered for sale for a designated price, the advance sale date preceding an occurrence date on which the page view is to occur; and
offering a futures contract for sale on an ad exchange for a portion of the designated price on a sell offer date that precedes the advance sale date using one or more processors of a processing system, the futures contract specifying an obligation to purchase the page view with respect to the occurrence date for the designated price.

18. The method of claim 17, wherein the designated price is equal to a spot price of the page view on the sell offer date plus a predetermined percentage of the spot price of the page view on the sell offer date.

19. The method of claim 18, wherein the portion of the designated price is inversely proportional to a duration of time between the sell offer date and the occurrence date.

20. The method of claim 17, wherein offering the futures contract comprises:
offering the futures contract for sale on the ad exchange for the portion of the designated price on the sell offer date that precedes the advance sale date by approximately six months.

21. The method of claim 17, wherein offering the futures contract comprises:
offering the futures contract for sale on the ad exchange for the portion of the designated price on the sell offer date that precedes the future date by approximately one year.

22. The method of claim 17, further comprising:
selling the futures contract for the portion of the designated price on the sell offer date;
offering for a first time period between the sell offer date and a first date to purchase the futures contract for a purchase price that is based on a fair market value of the futures contract, the first date occurring after the sell offer date and before the advance sale date; and
offering for a second time period between the first date and the advance sale date to purchase the futures contract for a predetermined purchase price.

23. The method of claim 22, wherein the first date precedes the advance sale date by approximately one month.

24. The method of claim 17, further comprising:
selling the futures contract for the portion of the designated price on the sell offer date to a purchaser; and
prohibiting the purchaser from selling the futures contract for a designated time period that precedes the advance sale date.

25. The method of claim 24, wherein the designated time period is approximately one month that ends on the advance sale date.
